(19) United States
(12) Patent Application Publication
(10) Pub. No.: US 2005/0219955 A1
(43) Pub. Date: Oct. 6, 2005

(54) Timepiece provided with an antenna

(76) Inventors: Qin Xu, Neuchatel (CH); Christian Piguet, Neuchatel (CH)

Correspondence Address: JACOBSON HOLMAN PLLC, 400 SEVENTH STREET N.W., SUITE 600, WASHINGTON, DC, 20004, US

(21) Appl. No.: 10/519,717

(22) PCT Filed: Jun. 30, 2003
(86) PCT No.: PCT/EP03/06908

§ 371 Date: Dec. 30, 2004

(30) Foreign Application Priority Data
Jul. 2, 2002 (EP) 02291651.4

(51) Int. Cl. G04B 37/00

(52) U.S. Cl. 368/88

(57) ABSTRACT

The invention concerns a timepiece, in particular a wristwatch comprising a middle (1), a watch movement (4) housed in the middle, a transmission and/or reception circuit (5) associated with said movement and an antenna (9) connected to said transmission and/or reception circuit. The invention is characterized in that the antenna (9) consists in an electrically conductive solid single-piece mass (10) shaped at least partly like a ring, said mass being arranged at the periphery of said middle (1). Furthermore, the antenna is connected to the transmission and/or reception circuit via a conductor (18) passing through the wall of the middle (1) over part of its thickness.

The present invention concerns a timepiece, in particular a wristwatch, furnished with an antenna making it possible to capture and, where appropriate, transmit radio signals.

With the aim of offering the horlogical market increasingly sophisticated high technology timepieces, and particularly wristwatches, the antenna used to communicate with the environment is becoming an essential component of the watch. Many embodiments of such antennae have been proposed in the past. They usually have in common their position inside the middle of the watch, for example beneath the glass or in a preformed lateral housing situated outside the perimeter of the dial. Other embodiments include an antenna in the bracelet of the watch. All these antennae must be connected to an integrated circuit comprising the circuits necessary to provide them with the transmission signal and/or to process the reception signal that they receive. The energy necessary to operate the assembly is usually provided by the battery which simultaneously supplies power to the horometric circuits of the timepiece.

Housing the antenna inside the case is used to protect it from unfavorable outside influences and makes it easier to connect with the integrated circuit of the timepiece. However, in this case, the antenna requires space inside the case and may only be extremely small while making the construction of the movement more complex. Furthermore, to provide the performance required of the antenna, it becomes necessary to make the case using a material that does not form a screen against the magnetic and electrical fields of the antenna.

The solution recommended in EP 0 844 685 remedies the disadvantages relating to the antenna being inside the case of the watch. In this case, the transmit/receive transponder is placed in its entirety in a bezel fitted, preferably in removable manner, onto the middle while surrounding the glass disk of the watch. Thus, the bezel has a structure which can be snap-fitted onto the case and forms a peripheral housing in which the transponder is placed. This housing is closed by an annular cover in plastic material necessary so that the interchange of electromagnetic energy with the antenna can take place.

Such a structure has the disadvantages of being complex and costly, the bezel furthermore having a totally particular appearance which prevents giving the watch a harmonious appearance compatible with a mid-range or top-of-the-range watch.

The purpose of the invention is to remedy these disadvantages.

The subject of the invention is therefore a watch having the features of claim 1.

Thanks to these features, the antenna has a very simple structure. In addition, the shape and outer appearance of the antenna may be such that the esthetics of the whole of the watch are compatible with the criteria that are usually imposed on mid-range and top-of-the-range watches.

Additional advantageous features of the watch according to the invention are defined in the subsidiary claims.

The invention will now be illustrated with the aid of several exemplary embodiments described by making reference to the appended drawing, given only as an example and in which:

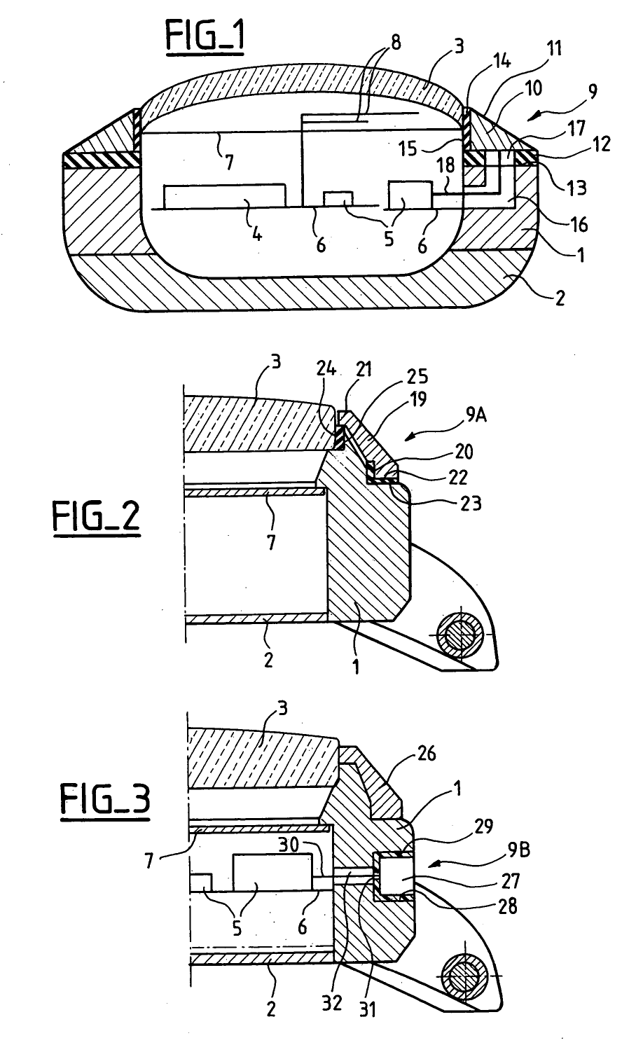

FIGS. 1 to 3 represent in very simplified manner and by respectively fully diametral and partially diametral sections, a timepiece produced according to the invention.

FIG. 1 represents a first possible embodiment of a timepiece, in particular a wristwatch according to the invention. It comprises a middle 1 closed by a back 2 and surmounted with a glass 3. In the middle 1 are housed a horometric movement 4 and a transceiver circuit 5 placed on one or more plates 6. The movement 4 and the circuit 5 are conventional and do not form part of the invention and so are not described in detail here. As an example, the transceiver circuit 5 may be formed by that described in European patent application No. 01 401 093.8 filed on Apr. 27, 2001 in the name of the Applicant and having as its title “Time keeping device with automatic time correction and method of correcting such a time-keeper”. Refer to this patent application for more detail. It is sufficient to remember here that it concerns a radio receiver used to provide the timepiece with the time signals that can be extracted from the RDS (Radio Data System) transmissions of most existing radio transmitters transmitting in frequency modulation. However, the present invention is not limited to a particular transceiver circuit, other than that it may be noted that the antenna designed according to the invention is particularly suited to operating at a frequency lying in the band of about 100 MHz.

A dial 7 is placed under the glass 3, the movement 4 driving hands 8 used here to display the time information. However, other types of displays known per se are possible.

According to the invention, the timepiece also comprises an antenna 9 which is formed in an electrically conductive annular solid monobloc mass 10, and, in the present example, of triangular section. This mass 10 may extend over a peripheral portion of the timepiece or, as a variant and in preference, consists of a closed monobloc ring extending over the whole periphery of the timepiece. It is made of a metal that conducts electricity well such as certain stainless steels or gold alloys or yet of an agglomerated composite material, such as zirconia (ZrO₂) for example, charged with electrically conductive particles. As in the present embodiment, the solid mass 10 forms the bezel of the timepiece at the same time as its antenna, its form and the nature of the material of which it is made must be compatible with the usual esthetic requirements in clock-making. To increase its qualities of resistance to the outside influences and particularly abrasion, the mass 10 is preferably coated on the outside with a layer made of hard material such as rhodium or diamond.

In the example in FIG. 1, the middle 1 is assumed to be made of a metal. As a result, the antenna 9 is attached to the middle by means of an insulator. The latter comprises an insulating washer 12 placed on the top annular face 13 of the middle and an insulating sleeve 14 placed at right angles to this washer 12 against the internal annular surface 15 of the solid mass 10. The glass 3 is fixed by chasing it into this sleeve 14 to ensure a perfect sealing of the assembly. In the drawing, the thickness of the insulator has been exaggerated for greater clarity. To give an idea, a thickness of between 1 and 2 mm may suffice.

The middle 1 comprises a right angle hole 16 which emerges on the one hand laterally on the inside of the middle and at the top in a hole 17 made in the insulating washer 12. The channel thus created is used for running a connection conductor 18 leading from the antenna 9 to the transceiver circuit 5.

The material of the washer 12 and of the sleeve 14 is preferably chosen from a group consisting of the nitrile rubbers, hydrogenated nitrile rubbers, polyurethanes, silicons, polymers or ceramics. Materials such as Zytel (polyamide resins fabricated by Dupont de Nemours) and Hytrel (thermoplastic elastomer) (registered trademarks) have preference. They help to achieve the seal between the glass 3 and the antenna 9.

The antenna 9 may be attached to the insulators 12 and 14 by any appropriate means known to watch-makers. In the example of FIG. 1, the attachment mode may be bonding.

It is evident that, if the middle is made of a plastic material, the insulator 12 between the solid mass 10 and the middle 1 may be omitted.

In the examples of FIGS. 2 and 3, the elements having the same functions and/or forms as in FIG. 1 carry the same reference numbers.

In the case of FIG. 2, the timepiece comprises an antenna 9A having a shape more profiled than the antenna 9 of FIG. 1 in order to improve the esthetics of the watch, the antenna 9 being, here also, used as a bezel. It has the shape of a monobloc ring 19 with frustoconical and coaxial internal and external surfaces, a ring to which are connected at the bottom an annular foot 20 and at the top a rim 21 extending radially. The middle 1 is machined in such a way as to have on the one hand an annular external seat 22 with bracket profile to which is applied a first annular seal 23 with bracket profile and electrical insulator and on the other hand a second internal annular seat 24 against which is pressed a second annular seal 25 in the form of a sleeve and also electrically insulating.

The antenna 9A forming a bezel is preferably chased onto the middle 1 with the interposition of the seal 23, while the glass 3 is preferably attached to the middle 1 by chasing into the seal 25. It will also be noted that thus the antenna 9A is insulated from the rest of the timepiece and forms a solid mass fully dedicated to the transceiver function, while constituting a bezel that in no way detracts from the esthetic appearance of the piece. To increase the abrasion-resistance of the antenna 9A, a protective layer may cover it as in the case of FIG. 1.

In the case of FIG. 3, it involves a watch which has a conventional structure with a middle 1 and a bezel 26 which here has an esthetic function only. This watch comprises an antenna 9B formed by a collar 27 in an electrically conductive solid monobloc mass which is set in an annular groove 28 made in the lateral surface of the middle 1. The antenna 9B is insulated from the latter by an insulating ring 29 which covers the back and the walls of the groove 28. The antenna 9B is connected to a transceiver circuit 5 of the timepiece via a conductor 30 passing through a hole 31 of the insulating ring 29 and a hole 32 leading from the groove 28 to the interior space of the watch.

In the example of FIG. 3, the middle 1 is made of metal such that the use of an insulating element such as the ring 29 is necessary. Naturally, it may be dispensed with if the middle is made of insulating material. If the back 2 is of metal, it may then serve as a ground plane for the antenna 9B. Otherwise, it is necessary to place against the back in an insulating material, and preferably against its inner face, a metal disk (not shown) connected to the transceiver circuit 5.

Irrespective of the embodiment of the watch according to the invention, the antenna 9, 9A or 9B is preferably designed as a non-resonant capacitive type antenna directly connected to the transceiver circuit 5 without interposition of discrete components such as inductors or capacitors. This type of antenna lends itself perfectly to the frequencies of the RDS transmissions of the radio stations transmitting in frequency modulation by which the timepiece can be time-corrected in accordance with the concept described in the aforementioned European patent application.

According to a variant that has not been represented in the figures, the antenna may be made in the form of a rotating bezel while providing sliding contacts to connect it to the transceiver circuit 5.

1-14. (canceled)

15. Timepiece, in particular wristwatch comprising a middle, a watch movement housed in the middle, a transceiver circuit associated with said movement and an antenna connected to said transceiver circuit, wherein said antenna is formed by a solid electrically conductive monobloc mass having the shape of at least a portion of a ring, this mass being disposed on the periphery of said middle, said antenna being connected to the transceiver circuit by way of a conductor passing through the wall of the middle on a portion of its thickness.

16. Timepiece according to claim 15, wherein said conductive solid mass forms a decorative portion thereof.

17. Timepiece according to claim 15, wherein said conductive solid mass is engaged in a groove made in the lateral surface of the middle, its outer surface just touching the lateral surface of the middle.

18. Timepiece according to claim 16, wherein said conductive solid mass forms at least a portion of a bezel of the piece surrounding the glass disk of the latter.

19. Timepiece according to claim 15, wherein conductive solid mass constitutes a closed ring.

20. Timepiece according to claim 15, wherein said middle being made of electrically conductive material, said conductive solid mass is separated therefrom by an insulator.

21. Timepiece according to claim 15, wherein said insulator is made of a material chosen from the group consisting of the nitrile rubbers, hydrogenated nitrile rubbers, polyurethanes, silicones, polymers or ceramics.

22. Timepiece according to claim 15, wherein said conductive solid mass and, where appropriate, said insulator are fixedly attached to said middle by at least one of the following operations: chasing, screwing, bonding, brazing, crimping and/or riveting.

23. Timepiece according to claim 15, wherein said conductive solid mass is made of a metal such as stainless steel or a gold alloy or made of an agglomerated composite mass, in zirconia for example, charged with conductive particles.

24. Timepiece according to claim 23, wherein said solid conductive mass is coated with a very hard layer, made for example of rhodium or diamond.

25. Timepiece according to claim 15, wherein it comprises a conductive element forming a ground plane for said antenna.

26. Timepiece according to claim 25, wherein said middle being metallic, said element forming the ground plane consists of the back of this middle.

27. Timepiece according to claim 25, wherein said middle being of an electrically nonconductive material, said element forming the earth plane consists of a metal disk placed inside the middle against the back of the latter.

28. Timepiece according to claim 15, wherein said antenna is of capacitive type and connected directly to said transceiver circuit.
